(19) United States
(12) Patent Application Publication
(10) Pub. No.: US 2006/0158037 A1
(43) Pub. Date: Jul. 20, 2006

(54) Fully integrated power storage and supply appliance with power uploading capability

(76) Inventors: Douglas Ricardo Danley, Germantown, MD (US); Carl Dreher, Dallas, TX (US); Andrew T. Wallo, Leesburg, VA (US); Craig H. Miller, Alexandria, VA (US)

Correspondence Address: BANNER & WITCOFF, 1001 G STREET N W, SUITE 1100, WASHINGTON, DC, 20001, US

(21) Appl. No.: 11/037,832

(22) Filed: Jan. 18, 2005

(51) Int. Cl. H02J 9/00

(52) U.S. Cl. 307/64

(57) ABSTRACT

Systems, methods and devices for integrating alternative energy sources and energy storage components into a single device with systems for control and safety monitoring to provide for use of the generated power on the premises, resale of power to the utility, and for power supply from storage and/or the alternative energy sources in the event of an interruption of supply from a utility's power grid. The device integrates the necessary components into a cabinet for use as a home appliance. The power storage and supply device cabinet contains essentially all necessary electrical components including charge controllers, inverters, relay circuitry, circuit breakers, and energy storage modules, such as batteries. A local controller device is disposed inside the cabinet and is configured to monitor and control the processes conducted by the power storage and supply device. The cabinet includes a ventilation system which uses an air intake located at the bottom of the cabinet for receiving air that is pulled into the lower section of the cabinet by fans located in the middle of the cabinet. The air is then circulated into the upper section of the cabinet where it is vented out through exhaust ports. Further, the cabinet of the power storage and supply device is compartmentalized by a separator panel that divides access to the compartments of the cabinet according to both levels associated with safety and a user's expertise.

### FIELD OF THE INVENTION

The present invention relates generally to power storage. More particularly, the present invention relates to a fully integrated device for power storage, and optionally, the integration of alternative energy sources into use on the premises and/or resale to a connected utility power grid.

### BACKGROUND OF THE INVENTION

There exist several technologies that can produce electricity on a premises, whether a residential or commercial building. Among these are photovoltaic panels (e.g., solar panels), small scale natural gas turbines (also known as micro-turbines), small-scale wind turbines (as contrasted to the large turbines used in grid connected wind farms), low pressure water turbines, high-pressure low flow water turbines, and fuel cells using hydrogen, natural gas, and potentially other hydrocarbons. These technologies are herein referred to as “alternative energy sources.” Alternative energy sources have been deployed only to a very limited extent for reasons of cost and convenience. Power storage and supply devices typically involve the charging of batteries that store energy in the event of a power failure of a home or business' main source of electricity, which is normally provided from a utility power grid connected to the home or business. Power backup is desirable for critical applications such as computers, refrigeration, medical technology, and security systems as well as convenience. Some power storage and supply devices use alternative energy sources, such as the ones listed above. The power storage and supply devices store the electric power produced by an alternative energy source and may even supply power to a utility power grid, in essence operating as a mini-power plant. Many local, state, and federal government agencies, as well as private utility companies, are encouraging this practice. Unfortunately, the use of alternative energy sources in conjunction with such power storage and supply device systems has been limited primarily because of cost and convenience.

In recent years, however, the expenses associated with using alternative energy sources has decreased substantially as the technology has been refined, sales have increased, and more suppliers have entered the market. The cost barriers to distributed electrical technologies are also eroding due to factors such as real and/or perceived increases in the cost of electricity and other forms of energy, favorable terms for the utilities' purchase of power from such distributed sources, and government financial incentives that encourage investment in distributed and environmentally more benign electrical technology.

The remaining barrier is convenience. At present there are significant challenges to an individual or building owner's installation of alternative energy technologies. In typical installations the component parts must be purchased from multiple vendors and integrated in a custom installation. Moreover, buying the component parts requires knowledge of the market for and the technical aspects of the different energy technologies, the construction required to install the technologies in accord with local codes, regulatory requirements, and guidelines imposed by homeowner's association and insurance companies. In addition, if the power generated in excess of requirements on the premise is to be resold, utilities impose additional requirements for connection of such systems to the utility's power grid. Another hindrance to implementing the use of alternative energy sources is that many local electricians do not yet know how to install the disparate components and frequently make errors in doing so, as much of this technology is new or not widely used. As a result of such errors and/or lack of know-how by the installer, the attendant wiring can be unattractive and intimidating to the buyer and lead to concerns and possibly actual issues regarding safety and reliability in addition to aesthetics.

Other hindrances are associated with battery installation operation, and maintenance. Typical backup energy storage systems relay on batteries, which inherently have a limited capacity. A battery's ability to fully charge diminishes after numerous cycles of charging and discharging. Without reconditioning the battery, the life span of the battery cells can be relatively short. Another problem arising from the large currents and voltages being constantly charged and discharged is the generation of heat, and at times significant amounts of heat. This heat loss itself is an inefficient use of energy and operates to degrade the components of the system, thereby shortening the life of their effective use. Also, batteries can be defective, and when dealing with large voltages, defective batteries can be dangerous. Moreover, the typical homeowner or business owner is not qualified or certified to provide adequate battery maintenance or battery replacement. This adds cost to the upkeep of an energy storage system.

Another problem that exists with the use of batteries as a means for supplying electricity to a utility power grid occurs in the untimely event of a power failure following the discharging of the power from the batteries to the utility power grid. This occurrence renders the backup energy storage device useless as a means of providing backup power to the home or business to which it is connected. In addition, current power storage and supply devices are generally considered loud, cumbersome, multi-component systems, that are too complex and dangerous for many business owners and homeowners. Often installation, maintenance, and operation of such systems are too time-consuming and expensive for a typical homeowner or business owner. Accordingly, what is needed is a backup power storage system that addresses the shortcomings of existing power storage systems, providing a safe, user-friendly backup energy source that is both cost-effective and easy to maintain.

### SUMMARY OF THE INVENTION

Generally stated, the present invention is directed to methods and systems for integrating alternative energy sources and energy storage into a single device with systems for control and safety monitoring to provide for use of the generated power on the premises, resale of power to the utility, and for power supply from storage and/or the alternative sources in the event of an interruption of supply from a utility's power grid. The device integrates the necessary components into a cabinet for use as a home appliance with the ability to upload stored power to a utility power grid connected to the home or provide a throughput from an alternative energy source directly to the utility power grid. The power storage and supply device cabinet contains essentially all necessary electrical components including charge controllers and inverters, as well as energy storage modules, such as batteries. The cabinet is capable of integrating the existing circuit breakers of a home into a circuit breaker panel integrated into the cabinet and accessible by a user through an access door or a user interface located on the outside of the cabinet. A local controller device is disposed inside the cabinet and is configured to monitor and control the processes conducted by the power storage and supply device. The cabinet of the power storage and supply device includes a ventilation system which uses an air intake located at the bottom of the cabinet for receiving air that is pulled into the lower section of the cabinet by fans located in the middle of the cabinet. The air is then circulated into the upper section of the cabinet where it is vented out. Further, the cabinet of the power storage and supply device is compartmentalized by a separator panel that divides access to the compartments of the cabinet according to both levels of user safety and expertise. For example, the circuit breakers are compartmentalized and accessible by any user; the power terminals are compartmentalized and configured for access only by a certified electrician; and the power electronics and batteries are compartmentalized and configured for access only by authorized personnel designated by the company that manufactured that particular power storage and supply device.

### BRIEF DESCRIPTION OF THE DRAWINGS

Having thus described the invention in general terms, reference will now be made to the accompanying drawings, which are not necessarily drawn to scale, and wherein:

FIG. 1 is a functional block diagram showing the backup power storage system, in accordance with an exemplary embodiment of the present invention.

FIG. 2 is a block diagram of the local controller, in accordance with an exemplary embodiment of the present invention.

FIG. 3 is a front view of the power storage and supply cabinet with its components shown, in accordance with an exemplary embodiment of the present invention.

FIG. 4 is a perspective view of the power storage and supply cabinet with certain internal features shown in phantom lines, in accordance with an exemplary embodiment of the present invention.

FIG. 5 is a top view of the power storage and supply device taken along lines 5′-5′ of FIG. 3, and showing the separated compartments of the power storage and supply device cabinet, in accordance with an exemplary embodiment of the present invention.

FIG. 6 is a perspective view of the one-piece separator panel that compartmentalizes the power storage and supply device cabinet, in accordance with an exemplary embodiment of the present invention.

### DETAILED DESCRIPTION OF THE PRESENT INVENTION

The present invention is directed to a device for the integration of alternative energy sources and energy storage with appropriate control system to provide for use of energy from the alternative sources by the premises, sales of power to a utility's power grid, and supply of power to critical and non-critical loads during loss of power from the utility power grid. Sale of power to the utility power grid is done in exchange for monetary benefits (e.g., energy credits, rebates, etc.) from a utility company or government entity. Moreover, the power storage and supply device is designed with enhanced safety and user-friendly features that allow for the integration of the power storage and supply device into the home as an appliance. The present invention is described below with reference to block diagrams of systems, methods, apparatuses and computer program products according to an embodiment of the invention. It will be understood that each block of the block diagrams and combinations of blocks in the block diagrams, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the block or blocks.

Accordingly, blocks of the block diagrams support combinations of means for performing the specified functions, combinations of steps for performing the specified functions and program instruction means for performing the specified functions. It will also be understood that each block of the block diagrams and combinations of blocks in the block diagrams can be implemented by special purpose hardware-based computer systems that perform the specified functions or steps, or combinations of special purpose hardware and computer instructions. The inventions may be implemented through an application program running on an operating system of a computer. The inventions also may be practiced with other computer system configurations, including hand-held devices, multiprocessor systems, microprocessor based or programmable consumer electronics, mini-computers, mainframe computers, etc.

Application programs that are components of the invention may include routines, programs, components, data structures, etc. that implement certain abstract data types, perform certain tasks, actions, or tasks. In a distributed computing environment, the application program (in whole or in part) may be located in local memory, or in other storage. In addition, or in the alternative, the application program (in whole or in part) may be located in remote memory or in storage to allow for the practice of the inventions where tasks are performed by remote processing devices linked through a communications network.

The present invention will now be described more fully hereinafter with reference to the accompanying figures, in which like numerals indicate like elements throughout the several drawings. Some, but not all embodiments of the invention are described. Indeed, these inventions may be embodied in many different forms and should not be construed as limited to the embodiments set forth herein; rather, these embodiments are provided so that this disclosure will satisfy applicable legal requirements, be thorough and complete, and will fully convey the scope of the invention to those skilled in the art.

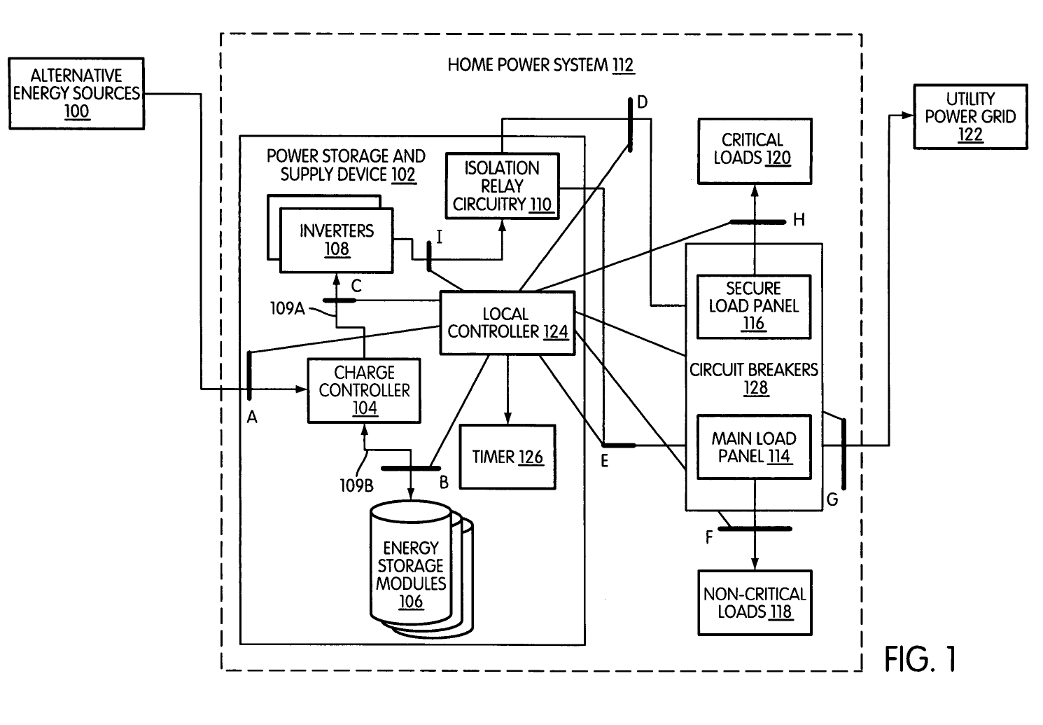

FIG. 1 is a functional block diagram showing a backup power storage system in accordance with an exemplary embodiment of the present invention. While the exemplary embodiment discussed herein is in the context of a home, it will be appreciated by those of ordinary skill in the art that the present invention is equally applicable to office buildings and other structures such as warehouses, manufacturing facilities, factories, small-businesses, storefronts, department stores, shopping centers, restaurants, malls and the like. As shown in FIG. 1, one or more alternative energy sources 100 are connected to a power storage and supply device 102 which is integrated into the pre-existing home power system 112. The home power system 112 is connected to a utility power grid 122, as is common with most residential homes. In an exemplary embodiment of the present invention, the alternative energy sources 100 are arrays of photovoltaic cells which convert sunlight into electricity, which is then sent as DC (direct current) voltage to the power storage and supply device 102. The photovoltaic cells may be a sub-array manufactured by BP Solar ( a subsidiary of British Petroleum, p.l.c.), Kyocera, Corp., Shell Transport and Trading Company, p.l.c., or Siemens Electrogeräte, GmbH, and operating normally at 90 VDC with a maximum output capacity at 2.5 kWp. Other photovoltaic cells produced by other manufacturers and operating at various currents, voltages, and power output capacities may also be used as alternative energy sources. Suitable forms of photovoltaic cells as well as other alternative energy sources (e.g., wind or water-based systems) may also be used. The alternative energy sources 100 also may be batteries, off-grid generators, micro-turbines, fuel cells, or any other suitable type of independent energy supply as appreciated by one of ordinary skill in the art.

The backup power supply device 102 includes a charge controller 104, one or more energy storage modules 106, one or more inverters 108, a local controller 124, a timer 126 and isolation relay circuitry 110, all of which are preferably in a single enclosed cabinet, such as the one discussed in more detail below. In an exemplary embodiment of the present invention each array of photovoltaic cells (acting as the alternative energy source 100) has a dedicated charge controller 104, though it is recognized that the charge controllers 104 can be configured in a number of ways appreciable by one of ordinary skill in the art. The charge controller 104 routes the electricity generated by the alternative energy source 100 to one or both of the energy storage modules 106 and the inverters 108 over lines 109A or 109B, respectively. Alternatively, the charge controller 104 may be controlled by another device, such as the local controller 124, which makes this determination. In an exemplary embodiment of the present invention, the charge controller 104 is an OutBack Power System's MX60 Charge Controller, but other suitable charge controllers may also be used.

Each energy storage modules 106 preferably contain a number of batteries, which in turn each contain a number of cells for storing the DC voltage being generated by the alternative energy sources 100. In an exemplary embodiment of the present invention, each energy storage module 106 includes ten battery cells, and four modules make up what is referred to as a string. However, one of ordinary skill in the art will appreciate various amounts of cells may be included in a module, various amounts of modules may be included in a string and other allocations and configurations of energy storage devices may be utilized in accordance with the present invention. The batteries may be nickel metal hydride (NiMh), nickel cadmium (NiCd), lithium (Li), lead, pure proton or any other suitable type of battery appreciable by one of ordinary skill in the art. However, other forms of energy storage other than batteries, such as capacitors and flywheels may also be used as energy storage modules 106.

The inverters 108 separate the DC output voltage on line 109A into time varying segments to produce an AC (alternating current) power signal, such as a 120/240 split-phase load current, which is typically the current supplied to a house. In an exemplary embodiment of the present invention, two inverters are used and are each an OutBack Power System's GTFX3048, 3000 Watt 48 Volt 120 VAC 60 Hz, but other suitable inverters and various numbers of inverters can also be used. The purpose of using two inverters is for the creation of three-phase power transfer. A single device could provide the two inverters and the creation of three-phase power. Moreover, several more inverters can be integrated into the power storage and supply device 102 to supply more power to more loads.

The isolation relay circuitry 110 preferably includes one or more automated switches for dynamically directing the AC power signal from the inverters 108 to a desired load. For example, in the exemplary embodiment, the power storage and supply device 102 may be configured to send power to both non-critical loads 118 and critical loads 120, to critical loads 120 only, or to the utility power grid 122 only. Critical loads 120 typically include water heaters, refrigerators, medical devices or whatever load the user has connected or specified as a critical load 120. Non-critical loads typically include televisions, fans, light fixtures, etc. One of ordinary skill in the art will appreciate various other relay schemes to optimize power delivery to the various loads within the home power system 112. The automated switches of the isolation relay circuit 110 may include a relay that is time dependent in that during one time interval the power is supplied to all loads, whereas in another time interval not all the loads are supplied power.

In addition to the isolation relay circuit 110, the determination of which loads receive electricity and which do not may be done manually by circuit breaker 128 typically including PSAC. In the exemplary embodiment, the circuit breaker 128 includes a main load panel 114 and/or a secure load panel 116.

The house circuit breakers 128 separate the premise's electrical wiring into separate circuits distinguishable as either critical (must not be interrupted) and non-critical (can be interrupted). In an exemplary embodiment, the switching of the flow of electricity on or off to critical loads 120 is handled by the secure load panel 116, and the switching of the flow of electricity on or off to non-critical loads 118 is handled by the main load panel 114. The circuit breakers 128 are also the entry point of electricity into the premises from the utility power grid 122. The house circuit breakers 128, preferably include PSAC (power system alternating current disconnects) circuit breakers and PSDC (power system direct current disconnects) circuit breakers. In alternative embodiments of the present invention, the circuit breakers 128 may be integrated into the power storage and supply device 102.

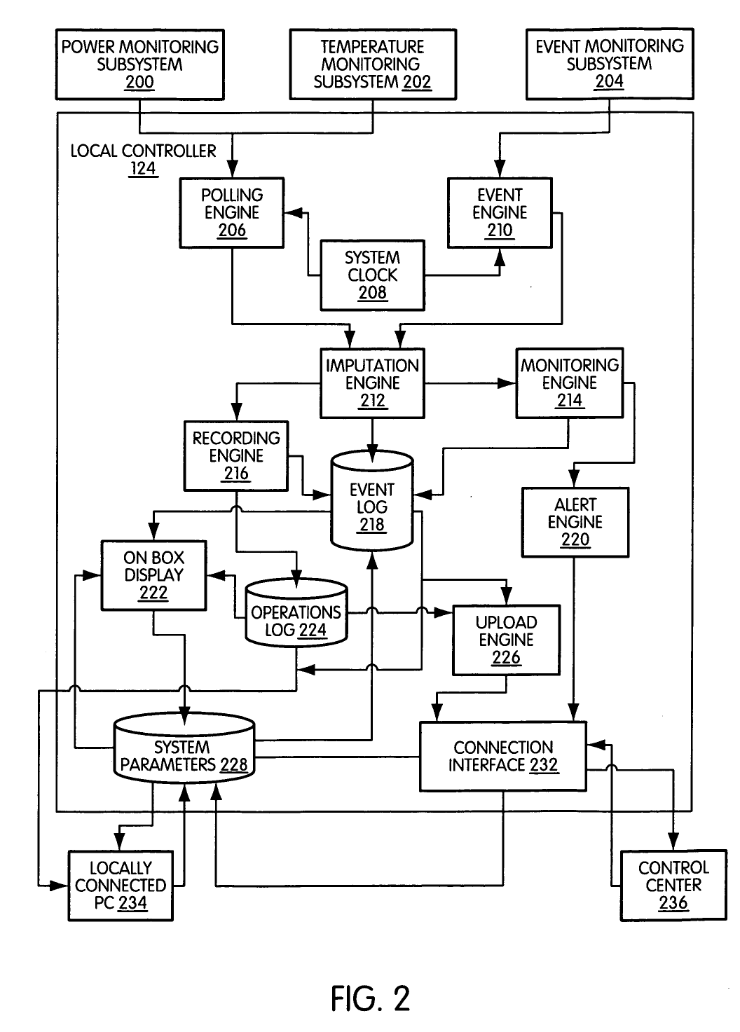

The local controller 124 monitors and controls most of the processes conducted by the power storage and supply device 102. The functionality of the local controller 124 and the associated timer 126 is discussed in more detail below with reference to FIGS. 1 and 2.

As shown in FIG. 1, the alternative energy source 100 generates and sends direct current (DC) voltage to the power storage and supply device 102 where the DC voltage is routed by the charge controller 104 to either the energy storage modules 106 over line 109B or the inverters 108 over line 109A. This determination is made by either the charge controller 104 (or the local controller 124). Preferably, the local controller 124 monitors whether or not the energy storage modules 106 are fully charged or are otherwise off-line. When the energy storage modules 106 are fully charged or off-line then the local controller 124 instructs the charge controller 104 to route the DC voltage being produced by the alternative energy source 100 directly to the inverters 108. When the batteries are on-line with the power storage and supply device 102 monitoring system, the local controller 124 can also be programmed to route the DC voltage to either the inverter 108 or the energy storage modules 106 based on the information detected by the monitoring system such as component and ambient temperature readings, time of day, instructions from the user interface or locally connected PC 234 (discussed below with reference to FIG. 2), weather reports or utility energy buyback pricing schemes received from the control center 236 (discussed below with reference to FIG. 2), or other information detected or received by the power storage and supply device 102 monitoring system. The operation of the local controller will be discussed in more detail below with reference to FIG. 2. Alternatively, the charge controller 104 can control where the DC voltage is routed based simply on whether the energy storage modules 106 are fully charged or not. If they are, then the DC voltage is routed to the inverters 108. If not, then its routed to charge the energy storage modules 106.

The DC voltage is preferably routed to the energy storage modules 106 when they require charging and are on-line with the power storage and supply device 102 monitoring system, otherwise the modules can possibly degrade, sustain damage, or be destroyed, any of which may also present a safety concern when dealing with high voltages. If the batteries are fully charged or off-line, then the DC voltage is routed to the inverters 108 to be converted to AC power and sent to the isolation relay 110. The isolation relay circuitry 110 then sends the AC power to certain loads based on its current settings. For example, it preferably sends the AC power to loads that require power at specific times (e.g., in the event of a power failure) or it sends the AC power through the main load panel 114 to the utility power grid 122, where the AC power is redistributed on the grid and energy credits (or other forms of monetary incentives) are earned by the home user from the utility company (or government entity) for supply power to the grid.

When there is a power outage and the alternative power sources 100 cannot supply power to sustain the required loads, the charge controller 104, or under the command of the local controller 124) directs (through switch circuitry or electric signal) the energy storage modules 106 to supply the inverters 108 with the stored DC voltage to be converted into AC power for use by the loads. The stored DC voltage in the energy storage modules 106 can also be converted by the inverters 108 into AC power and routed by the isolation relay circuitry 110 to the utility power grid 122 through the main load panel 114 at the command (through switch circuitry or electric signal) of the local controller 124.

FIG. 2 is a block diagram of the local controller 124 in accordance with an exemplary embodiment of the present invention. The local controller 124 provides a wide variety of functionality including the monitoring of power flows for purposes of assessing system performance, reporting, billing, the monitoring of components for degradation of performance, and monitoring system parameters for performance, safety concerns, and system maintenance purposes. In alternative embodiments of the present invention, the local controller 124 maintains a connection to external devices such as a locally connected personal computer (PC) 234 or a remotely located control center 236, and may facilitate the upload of monitoring data and send alerts in the case of system failure or repair/service. Further, the local controller 124 supports an on-device display disposed, for example, on the cabinet of the power storage and supply device 102, thereby allowing a home user or other user to retrieve basic operating information, conduct basic troubleshooting, and update the system parameters. In alternative embodiments of the present invention an on-device external connection to the controller 124 may be provided to allow a user to connect an external device having special software loaded thereon, such as a laptop, PDA, cell phone, etc., to run a diagnostics check on the system for troubleshooting system anomalies.

The local controller 124 is a computer implemented device that may include, for example, one or more processors, a clock, memory, I/O interfaces, analog to digital converters, digital to analog converters, and operating system software. In addition, the local controller 124 includes a number of software modules, also referred to herein as engines, for implementing the functionality discussed below with reference to FIG. 2.

As shown in FIG. 2, the local controller 124 is connected to three monitoring subsystems: the power monitoring subsystem 200, temperature monitoring subsystem 202, and event monitoring subsystem 204. All three monitoring subsystems have the ability to use the timer 126 in conjunction with sending data to the local controller 124. The use of the timer 126 can include determining when to perform a read or other function, or for time stamping data to be sent to the local controller 124.

The power monitoring subsystem 200 monitors power flows within the home power system 112. FIG. 1 shows the points A-I where power flow is measured and/or calculated by the power monitoring subsystem 200. Not all monitoring points may be used in all versions and all installations. At each point, there are four basis types of data that may be monitored—voltage (colts), current (amperes), power (kW), and energy (kWh). In the exemplary embodiment, points A, B, and C monitor direct current and points D, E, F, G, H, and I monitor power flow. One of ordinary skill in the art will appreciate the various sensors devices that can be used to detect and convert the measured values to signals that can be sent to and analyzed by the local controller 124. In certain embodiments, the sensors at points A-I may merely measure the values and any necessary calculation will be done by the local controller 124.

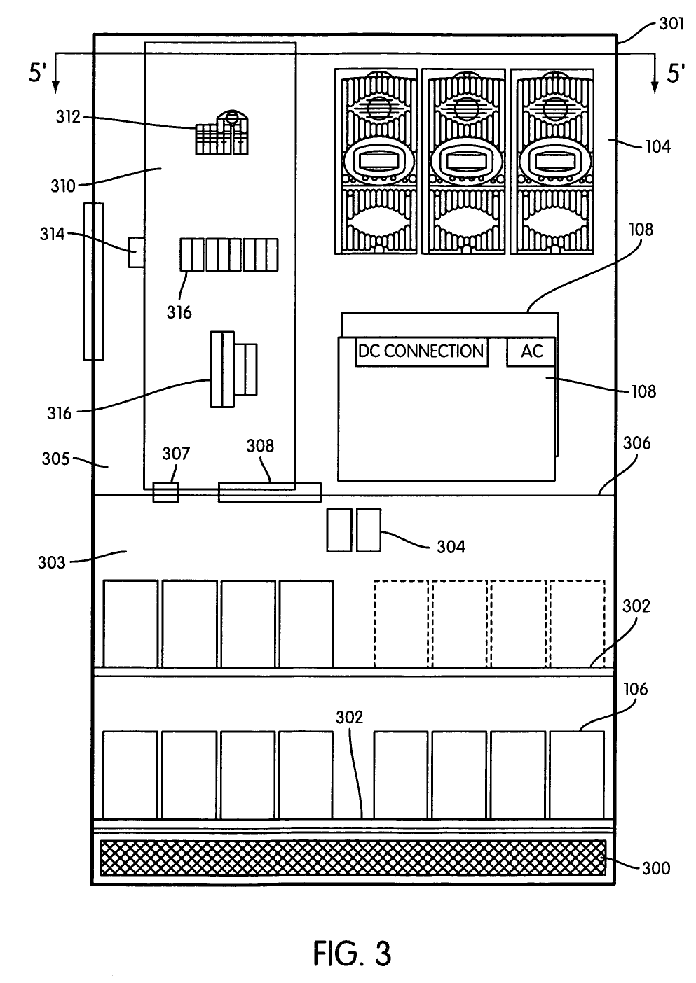

The temperature monitoring subsystem 202 monitors the temperature of the components and the ambient environment inside and outside the cabinet housing the power storage and supply device 102. In an exemplary embodiment of the present invention the temperatures monitored include the temperature of each inverter 108 and charge controller 104 (which each device may be capable of doing itself), the temperature inside the cabinet housing the backup storage device 102 (the backup storage device cabinet is discussed in further detail below with reference to FIG. 3-5), and the temperature of each energy storage module 106. Other components and parts of the system may be monitored with regard to temperature where desired, as will be appreciable by one of ordinary skill in the art.

The temperature monitoring subsystem 202 may also include fans associated with various components and/or the power storage and supply device cabinet for controlling the operating temperature of the backup storage device 102. For example, the exemplary embodiment includes at least one fan located inside the cabinet (discussed in more detail below) to regulate the temperature inside the cabinet. The actuation of the fan(s) is controlled by the local controller 124 and is based at least in part on the temperature readings provided by the temperature monitoring subsystem 202. In alternative embodiments of the present invention, other temperature monitoring can be done by the local controller 124 including utilizing weather reports downloaded to the local controller 124 from the locally connected PC 234 or the control center 236 to allow the power storage and supply device 102 to configure itself appropriately in anticipation of adverse weather conditions. For example, if it is expected to rain or snow all day and the day is relatively short because it is in the middle of winter, then the power storage and supply device might store energy to the energy storage modules 106 rather than upload it directly to the utility power grid 122 because of the increased probability that the photovoltaic array will not generate enough power to sustain the necessary power levels for that day or the increased probability of a power outage on the utility power grid 122.

The event monitoring subsystem 204 monitors messages from the components of the power storage and supply device 102 of signals indicating anomalies or errors in operation. Such devices can include sensors as well as devices that are integrated into components themselves, such as the inverters 108, charge controllers 104, and energy storage modules 106. For example, if an energy storage module 106 is a “smart” battery it will include circuitry and functionality for sending battery information to the local controller 124 via the event monitoring subsystem 204 for analysis. This information may enable the local controller 124 to track how many times the batteries are charged since reconditioning, how long until the batteries are fully charged/discharged, etc. In an exemplary embodiment of the present invention the event monitoring subsystem 204 includes monitoring for error codes reported by each inverter 108, such as a signal to the local controller 124 to shut down the entire system due to the inverter being dangerously hot, and error codes reported by each charge controller 104. The event monitoring subsystem 204 may also monitor a switch that indicates when a door to the cabinet is open or closed, a signal from the fan that it has stopped operating, a detection of water breaching the cabinet, a detection of smoke signaled by an audible alarm and a signal from a smoke detector.

As shown in FIG. 2, the power monitoring subsystem 200 and the temperature monitoring subsystem 202 are processed by the local controller 124 differently than the event monitoring subsystem 204. In particular, with both the power monitoring subsystem 200 and the temperature monitoring subsystem 202, rather than wait for an alert (or interrupt), the local controller 124 periodically polls the detection points of the power monitoring and temperature monitoring subsystems 200, 202. The polling engine 206 polls the various detection points of the subsystems 200, 202 periodically until it detects information to process. Once information has been received, it retrieves the data and time stamps it using the timer 126. Unlike the power monitoring and temperature monitoring subsystems 200, 202, the event monitoring subsystem 204 detects alerts (or interrupts) that initiate processing by the local controller 124. Once an alert is detected, the event engine 210 time stamps the event data utilizing the timer 126. A system clock 208 synchronizes the various engines running in the local controller 124 by providing a reference time for all of the local controller 124 components.

The rest of the process is essentially the same for processing data retrieved from all three subsystems 200, 202, and 204. The data is initially passed to an imputation engine 212 where any necessary calculations are performed. These calculations are typically those to recover meaningful data that cannot be measured directly and/or estimations of missing data. The imputation engine 212 also creates an operations log for the analysis. The time stamped data is then stored in an event log 218 by a recording engine 216. The recording engine 216 also stores the complete operations records in an operations log 224. Next, an upload engine 226 facilitates transfer of the event log 218 to the control center 236 and possibly other authorized users through the connection interface 232. The upload engine 226 also validates the accuracy of the upload.

In addition to the above process, after the data that passes through the imputation engine 212 is manipulated appropriately, then the data is passed to a monitoring engine 214 where the data is analyzed to determine if the action is required by checking for anomalies or dangerous conditions. For example, if the data represents a measurement that does not fall within predefined parameters or exceeds a maximum value, then this may be indicative of an anomaly or dangerous condition. If so, this analysis is recorded as a separate entry in the event log 218. The monitoring engine 214 may also invoke the alert engine 220 if the component being monitored exceeds specified parameters stored in the system parameters 228 (discussed in further detail below), requiring immediate human or control center 236 attention. The alert engine 220 then distributes an appropriate notice to designates recipients via XML, FTP, SMS, Email, telephone outcall, page, or other means appreciable by those of ordinary skill in the art. The notices can be distributed to various recipients based upon what type of alert/error was detected. The recipient may receive reminder notices until the alert/error is acknowledged. The connection interface 232 maintains connection to a control center 236 remote from the power storage and supply device 102. The connection can be through dialup, satellite, cable, DSL, wireless 802.11x, or other communication means appreciable by one of ordinary skill in the art.

The system parameters of the local controller 124 are stored in the system parameters 228. The system parameters 228 include data stored for system configuration, operating parameters for components of the power storage and supply device 102, and parameters for safety checks. The system parameters 228 can be accessed and modified via the on-box display 222, a locally connected PC 234, and the control center 236. The on-box display 222 and locally connected PC 234 are located on the premises. The control center 236 is remotely located from the premises and may be connected to multiple local controllers 124. In a preferred embodiment of the present invention, the on-box display 222 is a user interface built into the power storage and supply device 102 for displaying system parameters 228, summaries of operating data from the operations log, and selected event data. Through the on-box display 220 and/or an associated keypad the user can input data to perform limited changes to the system parameters 228. The locally connected PC 234, in an exemplary embodiment of the present invention, is a personal computer that is not part of the power storage and supply device 102 and performs the same functions as the remote control center 236 in accessing data and updating system parameters 228. Moreover, the control center 236 can send signals to the local controller 124 for the local controller 124 to take various actions both in monitoring and control of the power storage and supply device 102. For example, the control center 236 can sending signals relating to utility energy buyback pricing schemes to the local controller 124 to have the charge controller 104 route the DC voltage to the inverters 108 rather than the energy storage modules 106 to optimize the economic benefits received by a utility company for uploading power to its power grid 122 based on user preferences related to that particular power storage and supply device 102.

All of these points of access provide for an interface to retrieve system parameters 228 and to enter new values. However, the user at any point of access may be required to log into the power storage and supply device 102 with authorization information (e.g., user name and password) and may have limited access rights based on their user profile. All changes to system parameters 228 are logged as events in the event log 218.

The physical configuration of the power storage and supply cabinet 301 and the components included therein is now designated with references to FIGS. 3-6. FIG. 3 is a front view of the interior of the backup storage cabinet 301 that includes the power storage and supply device 102 in accordance with an exemplary embodiment of the present invention. As shown in FIG. 3, the backup power supply cabinet 301 is divided into a lower section 303 and an upper section 305 by a divider shelf 306. In an exemplary embodiment of the present invention, the backup power supply cabinet 301 is a stainless steel casing measuring 5′H×3′W×2′D. However, one of ordinary skill in the art will appreciate other casing materials and cabinet dimensions may be utilized.

The lower section 303 of the power storage and supply cabinet 301 contains the energy storage modules 106 and components that make up the ventilation system of the power storage and supply device 102. Also located in the lower section 303 of the power storage and supply cabinet 301 is an electrical bus connecting the battery cable terminals 304 to a main bus, which connects to the charge controller 104 and the inverters 108 located in the upper section 305 through the cable access aperture 307. The battery cable terminals 304 are located on the back of the lower section 303 of the power storage and supply cabinet 301 and includes at least one connector for providing a quick connect configuration for the energy storage modules 106. A shunt switch may be provided for physically isolating (via disconnection) the energy storage modules 106 from one another. This configuration allows for physical and electric isolation of an energy storage module 106 by switching the module off, effectively unplugging that specific module from the system. This functionality allows for safe maintenance and upkeep of the energy storage modules 106 while avoiding the interruption of the operation of the power storage and supply device 102. This also lets the local controller 124 avoid damage to the entire system by isolating a non-properly functioning energy storage module 106 until such module can be repaired or replaced by the appropriate maintenance worker. A preferred quick connect configuration for connecting the modules 106 to the battery cable terminals 304 is the battery hot-swap system developed by Cobasys, Inc.

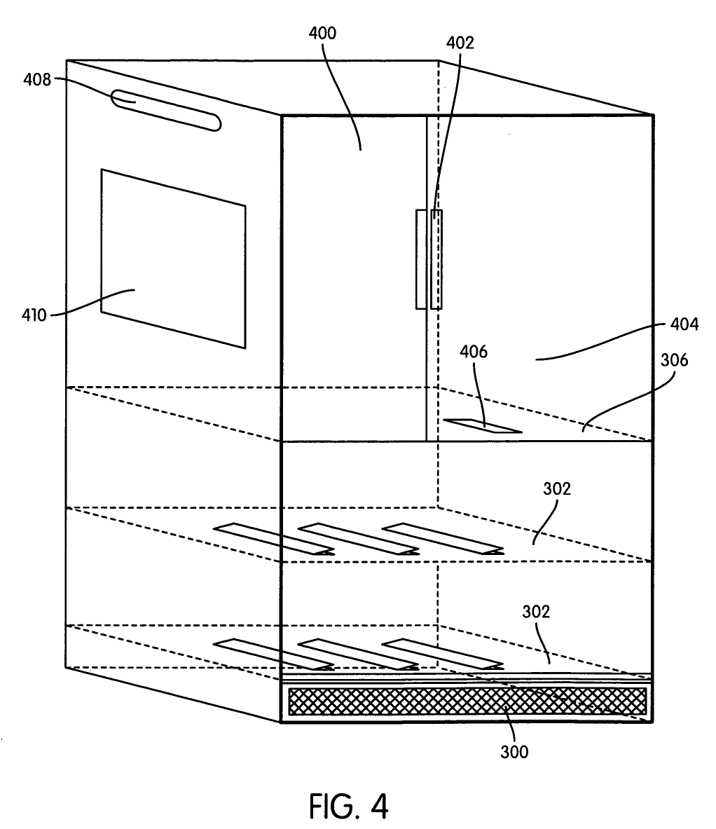

As shown in FIGS. 3 and 4, the lower section 303 of the backup power supply cabinet 301 also includes one or more ventilated shelves 302, subdividing the lower section 303 in to shelves for energy storage devices 106. The ventilated shelves 302 provide support and additional space for the energy storage modules 106. The ventilated shelves 302 are ventilated in that they include elongated slots and/or holes (i.e., apertures or gaps) and integrated, raised grooves formed from the slots or holes. The slots and/or holes provide the ventilation by being disposed where they will not be obstructed by the energy storage modules 106 resting on the ventilated shelves 302, allowing air to pass between the subdivided levels of the lower section 303 of the backup power supply cabinet 102. Advantageously, the raised grooves on the ventilated shelves 302 also provide guides for positioning and aligning the energy storage modules 106 on the ventilated shelves 302. This feature also aids energy storage module 106 swapping when one or more modules has been isolated by the local controller 124 due to the detection of improper module functionality. In an exemplary embodiment of the present invention straps can also be used to hold the energy storage modules 106 in place on the ventilated shelves 302.

The slots in the ventilated shelves 302 are preferably configured in such a way to provide adequate space between the energy storage modules 106 to facilitate the desired level of air flow between the energy storage modules 106, thereby assisting in ventilation. This formation allows for better cooling of the energy storage modules 106 and helps allow air to reach to the upper section 305 of the power storage and supply cabinet 301. By controlling the size and density of the slots and holes the volume of air circulating through the cabinet 301 can be affected.

The divider shelf 306 includes one or more cut outs to allow access between the upper section 305 and lower section 303 of the power storage and supply cabinet. In the exemplary embodiment shown in FIGS. 3 and 4, there are two such cut outs. The first is a cable access aperture 307 allowing cables to be run from the components located in the upper section 305, such as the inverters 108 and charge controllers 104, to the battery cable terminals 304 located in the lower section 303. The second cut out is for one or more ventilation fans 308. The ventilation fans 308 are provided to pull air in from outside of the cabinet 301 and up through the lower section 303 and into the upper section 305 of the power storage and supply cabinet 301 to keep the ambient temperature in the upper section 305. Thus, the amount of energy wasted by heat being emitted from the components, such as the inverters 108 and charge controllers 104, is decreased. The size of the second cut out for one or more of the ventilation and fans 308 and the number of ventilation fans 308 used determines the cubic feet of air per minute (CFM) rate that is circulated throughout the power storage and supply cabinet 301. The higher the speed of the fans, the larger the cut out where the air passes between the lower section 303 and upper section 305 and other factors increasing air flow cause the CFM rate to be higher. However, there are trade offs with noise and power consumption. Preferably, the factors affecting the CFM rate are adjusted so as to adequately cool the components in both the lower section 303 and the upper section 305 of the power storage and supply cabinet 301 while maintaining the lowest noise output level possible.

A ventilation intake 300 is provided at the bottom of the power storage and supply cabinet 301. The ventilation intake 300 is an inlet vent or slotted panel at the bottom of the lower section 303 of the power storage and supply cabinet 301. It provides a passage way for outside air to enter the power storage and supply cabinet 301. In certain exemplary embodiments of the present invention, the ventilation intake 300 may contain a filter device to filter particulates in the air being circulated through the power storage and supply cabinet 301. The types of filters used would be any that filter particulates out of the air as is commonly used to filter air circulating through large communication equipment, as appreciable by one of ordinary skill in the art. After the air passes through the ventilation intake 300 it proceeds up through the ventilated shelves 302 and between the energy storage modules 106, cooling them along the way and eventually passing through the at least one ventilation fan 308 of the divider shelf 306.

The ventilation fans 308 are attached to or adjacent an aperture in the divider shelf 306. The ventilation fans 308 pull the air from outside the cabinet 301 in through the ventilation intake 300 and up through the ventilated shelves 302 by creating negative pressure in the lower section 303, while creating positive pressure in the upper section 305. The positive pressure in the upper section 305 is caused by the ventilation fans pushing air into the upper section 305 of the cabinet 301 and circulating the air in the upper section 305. This circulation cools the electrical components located in the upper section 305 of the cabinet 301, including the charge controllers 104 and inverters 108. The air exits the cabinet through exhaust ports 408 located in the upper section 305 of the cabinet 301. The exhaust ports 408 (as shown in FIG. 4) are holes or slots, which are preferably located on the sides of the power storage and supply cabinet 301 near the top of the upper section 305.

Also shown in FIG. 3 are the components of the upper section 305 of the backup power supply cabinet 301. The upper section 305 of the backup power supply cabinet 301 houses the electrical components such as the charge controllers 104, the inverters 108, as well as an electric panel 310, which houses AC circuit breakers 312, DC circuit breakers 316 and terminals 314. In the upper section 305 of the power storage and supply cabinet 301, the charge controllers 104 are vertically mounted on rails connected to the back wall of the backup power supply cabinet 301 and the inverters 108 are horizontally mounted on the divider shelf 306. This configuration of the charge controllers 104 and inverters 108 allows for easier routing of the cables which are used to connect the two devices. Moreover, it allows for advantageous weight distribution for the inverters 108, which are relatively heavy, thereby adding stability and seismic protection to the backup power storage system 102. It also makes the connection to the energy storage modules 106 through a cable access aperture 307 in the divider shelf 306 easier to route as well. Further, this configuration allows easier access to both the charge controllers 104 and inverters 108 should the need ever arise to repair or replace the charge controller 104, inverters 108, or the cables that connect them to each other.

The upper section 305 of the backup storage cabinet 301 also houses the local controller 124. However, the local controller's 124 monitoring and communication capabilities are routed through both the upper section 305 and lower section 303 of the power storage and supply cabinet using the cable access aperture 307 in the divider shelf 306, which also provides routing for the cables connecting the energy storage modules 106 to the charge controllers 104 and inverters 108.

In the upper section 305 of the power storage and supply cabinet 301, the electrical panel 310 contains AC circuit breakers 312 and DC circuit breakers 316, which are switches that allow the home user to turn on or off the flow of AC or DC currents to the components of the backup power supply device 102. In an exemplary embodiment of the present invention, the circuit breakers 128 of the home power system 112 can also be integrated into the electrical panel 310 of the backup power supply device 102. For example, the home user may use the electric panel 310 to turn on the backup power supply device's 102 ability to store DC voltage in the energy storage module 106 by switching one of the DC breakers 316, while also turning off the AC power supply to a specific room in the house by flipping another switch in the electrical panel 310 corresponding to one of the AC breakers 312. Finally, the terminals 314 located in the upper section 305 of the power storage and supply cabinet 301 are used to connect the backup power supply device 102 to the corresponding circuit breakers 128 for facilitating the connection of the power storage and supply device 102 to the home power system 112 and the utility power grid.

As shown in FIG. 4, access to the electrical panel 310 may be provided to the home user by the small access door 400. In alternative embodiments of the present invention, the home user may not need to open the small access door 400 because a user interface may be provided on the power storage and supply cabinet 301, or alternatively, provided through an opening in the exterior of the cabinet 301. The user interface may include a display and a user input device such as a touch screen or keypad or keyboard, which will provide the home user access and control over the AC circuit breakers 312 and DC circuit breakers 316 without having to access the interior of the power storage and supply cabinet 301. In an exemplary embodiment of the present invention, the large access door 404 may be locked so it can only be opened by authorized personnel. This ensures a higher level of safety for the home user by preventing access to the high voltage and potentially dangerous components of the backup storage device 102 such as the inverter, high-energy cables and charge controllers 104.

Similarly, a secured access plate 410 may be provided in cabinet 301. The secured access plate 410 can be removed by authorized personnel to allow access to the terminals 314 for connecting the components of the power storage and supply device 102 to the home power system 112 and/or the utility power grid 122. In exemplary embodiments of the present invention the means for limiting access of these devices includes warning labels, warranty seals (i.e., seals which if broken by the home user would void any warranty provided by the manufacture), various locks, password protected locks and customized mechanical tools made specific to a unique access panel, as well as other access limiting means appreciable by one of ordinary skill in the art.

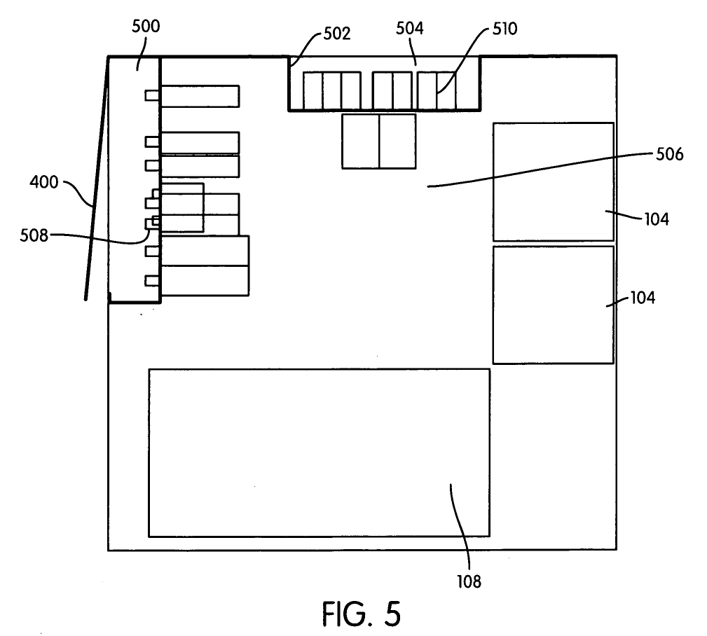

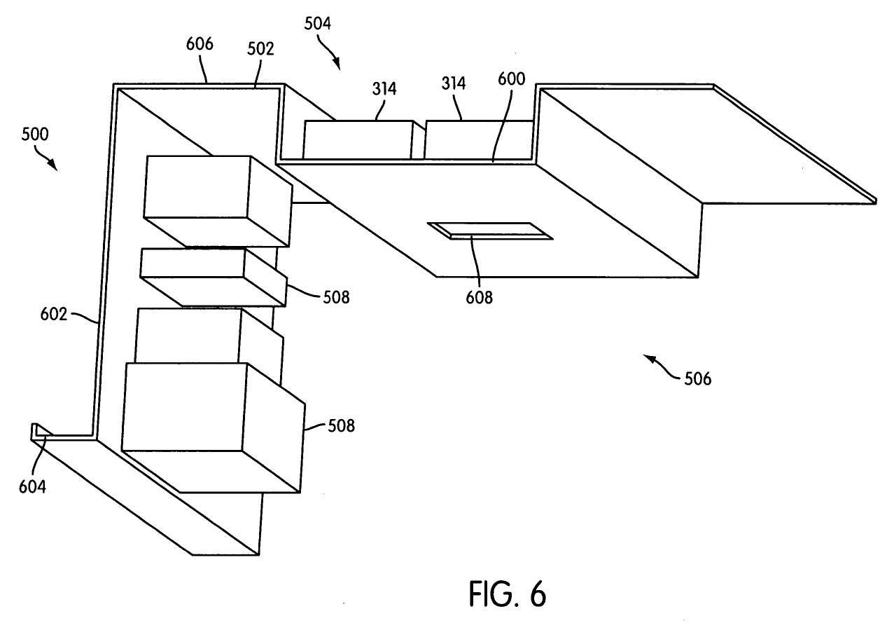

FIG. 5 is a top plan view of the upper section 305 of the power storage and supply cabinet 301 showing the separated compartments of the upper section 305 in accordance with an exemplary embodiment of the present invention. As shown in FIG. 5, the upper section 305 of the power storage and supply cabinet 301 is separated into three compartments by a one-piece separator panel 502. The separator panel 502 is configured from a single piece of metal (or other suitable material) with a series of bends and cut outs to allow certain components to be attached to it (e.g., power terminals, circuit beaker switches, etc.). The main purpose of the separator panel 502 is to divide the upper section 305 of the power storage and supply cabinet 301 into compartments according to levels of user access. The separator panel 502 will be discussed in more detail with reference to FIG. 6 below.

The first compartment 500 houses, for example, the AC and DC circuit breakers 312 and 316 respectively. The first compartment 500 is accessible by the home user to allow the user to have control of the circuit breakers 508. In an exemplary embodiment, the first compartment is accessible only by opening the small access door 400. However, the separator panel 502 prevents the home user that is accessing the first compartment 500 from having access to the second compartment 504 or the third compartment 506, both of which include potentially dangerous high-voltage components.

The second compartment 504 houses, for example, the terminals 314. The terminals 314 connect the power storage and supply device 102 to the utility power grid 122 through the houses main load panel 114, as well as connect the power storage and supply device 102 to the home power system 112. The second compartment's 504 access preferably is restricted to a professional electrician and/or a designated person by the company producing the power storage and supply cabinet 301, and is accessible through the access plate 410, shown in FIG. 4.

The third compartment 506 houses, for example, the charge controllers 104 and the inverters 108. The third compartment is the most restricted access compartment, where access is only appropriate if designated by the manufacturer of the power storage and supply device 102. The third compartment 506 also houses the local controller 124. These devices are not only potentially dangerous, they are also critical to the proper performance of the power storage and supply device 102. In exemplary embodiments of the present invention the means of limiting access of these devices includes warning labels, warranty seals (i.e., seals which if broken by the home user would void any warranty provided by the manufacture), various locks, password protected locks and customized mechanical tools made specific to a unique access panel, as well as other access limiting means appreciable by one of ordinary skill in the art.

FIG. 6 is a perspective view of the separator panel 502 that compartmentalizes the upper section 305 of the power storage and supply device cabinet in accordance with an exemplary embodiment of the present invention. The separator panel 502 is a metal structure of one piece construction with a first panel section 602 having a lip piece 604 integrally connected at one end and is integrally connected to a second panel section 606 at the other end. The first panel section 602 and lip piece 604 provides the back of the first compartment 500 and separates the first compartment 500 from the other two compartments. The second panel section 606 of the separator panel has a notched section 600 near the center of it to provide the second compartment 504 and separates access to the second compartment 502 from the third compartment 506.

While FIGS. 5 and 6 show a separator panel 502 dividing the power storage and supply device into three compartments, one of ordinary skill in the art may appreciate increased safety measures and component isolation by the addition of more isolating compartments. FIG. 6 also shows how the one-piece separator panel 502 contains customized cut outs to allow only for the necessary parts of the internal components of the power storage and supply device 102 to protrude through to another compartment. For example, the circuit breakers 508 can be mounted flush against the separator panel 502 so the user may control the operation of the circuit breakers 508 using the control knobs/switches protruding through the separator panel 502, which are accessible in the first compartment 500. Another example is the aperture 608 between the second compartment 504 and the third compartment 506, as shown in FIG. 6. The aperture 608 allows the power terminals to protrude through and allow for an electrician to easily connect the internal components of the power storage and supply device to both the alternative energy source 100 and the utility power grid 122.

Many other modifications and additional features will also become evident in view of the preceding description of exemplary embodiments of the invention. It should be appreciated that many features and aspects of the present invention are described above by way of example only and are therefore not intended to be interpreted as required or essential elements of the invention, unless so stated. Accordingly, the foregoing relates only to certain embodiments of the invention and numerous changes may be made therein without departing from the spirit and scope of the invention as defined by the following claims.

That which is claimed:

1. A energy storage and supply device configured for connection to an energy source and a home power system having at least one load, wherein the home power system is connected to a utility power grid, comprising:
a plurality of energy storage modules;
a plurality of inverters;
a plurality of charge controllers configured to receive energy from the energy source and provide the energy to one or more of the plurality of energy storage modules and the plurality of inverters;
at least one relay switch configured to receive energy from at least one of the plurality of inverters and provide the energy to one or more of the utility power grid and the load of the home power system; and
a local controller that controls the operation of the plurality of charge controllers and the at least one relay switch.

2. The energy storage and supply device of claim 1, further comprising:
a cabinet for enclosing the energy storage modules, inverters, charge controllers, and local controller;
wherein at least one shelf in the cabinet includes a plurality of raised grooves, wherein each of the plurality of raised grooves provides a guide for slidably receiving at least one of the plurality of energy storage modules.

3. The energy storage and supply device of claim 2, wherein the cabinet includes a divider shelf disposed therein, and wherein the divider shelf includes an aperture and an associated fan.

4. The energy storage and supply device of claim 2, wherein the raised grooves in the one shelf comprise elongated slots.

5. The energy storage and supply device of claim 1, further comprising a circuit breaker interconnecting the at least one relay switch the utility power grid and the load of the home power system.

6. The energy storage and supply device of claim 1, wherein the local controller includes at least two of a temperature subsystem for monitoring temperatures associated with the device and components thereof, a power monitoring subsystem for measuring energy flows and an event monitoring subsystem for monitoring events that may effect the performance of the device.

7. The energy storage and supply device of claim 6, wherein the local controller controls the operation of the plurality of charge controllers and the at least one relay switch based at least partially on readings from one or more of the temperature subsystem, a power monitoring subsystem and an event monitoring subsystem.

8. The energy storage and supply device of claim 6, wherein the power monitoring subsystem obtains power measurements from various points throughout the device and generates an alert if the power measurements are not within a predetermined range.

9. The energy storage and supply device of claim 6, wherein the temperature monitoring subsystem generates an alert when one or more of the monitored temperatures is outside a predetermined range.

10. The energy storage and supply device of claim 6, wherein the event monitoring system collects error and status data from components in the device, records the error and status data, and checks each data entry to determine if an immediate device shutdown should be performed or if a notice of failure message should be generated.

11. A system for ventilating a power storage and supply appliance, comprising:
a cabinet housing electrical components for power storage and supply,
wherein the cabinet comprises,
a lower section including energy storage modules,
an upper section including inverters and relay devices for controlling the operation of the energy storage modules, and
wherein the upper section and lower section are separated by a divider shelf, and wherein the divider shelf includes at least one aperture and at least one fan associated with the at least one aperture to move air from the lower section of the cabinet to the upper section of the cabinet.

12. The system for ventilating the appliance of claim 11, further comprising a plurality of slotted shelves located in the lower potion of the cabinet.

13. The system for ventilating the appliance of claim 12, further comprising a filter, wherein the filter is disposed in the lower section of the cabinet beneath the lowest slotted shelf.

14. The system for ventilating the appliance of claim 11, wherein the upper section includes at least one door and at least one access plate for accessing the electrical components internally disposed in the upper section of the cabinet.

15. The system for ventilating the appliance of claim 14, further comprising a separator panel that subdivides the upper section into at least three separate compartments, at least two of which are individually accessible by the at least one door and at least one access plate.

16. A multi-level access enclosure system for an energy storage and supply device comprising:
a cabinet, wherein the cabinet includes,
a lower section housing a plurality of energy storage modules, and
an upper section housing electrical components for controlling the operation of said energy storage modules, wherein the upper section includes at least one door and one access plate;
a separator panel disposed in the upper section of the cabinet to divide the upper section into a first compartment, a second compartment and a third compartment, wherein the separator plate provides selective accessibility to the components through the at least one door and at least one access panel.

17. The multi-level access enclosure system of claim 16, wherein the first compartment is formed to block access to the second compartment and the third compartment the second compartment blocking access to the first compartment and the third compartment and the third compartment blocking access to the first compartment and the second compartment.

18. The multi-level access enclosure system of claim 16, wherein the first compartment houses at least one of a plurality of circuit breakers, wherein the second compartment houses at least one of a plurality of terminals, and wherein the third compartment houses at least one of a plurality of controllers and at least one of a plurality of inverters.

19. The multi-level access enclosure system of claim 18, wherein at least one circuit breaker is mounted to the separator panel.

20. The multi-level access enclosure system of claim 18, wherein at least one of a plurality of terminals is mounted to the separator panel.

21. The multi-level access enclosure system for an energy storage device of claim 16, wherein the upper section and lower section are separated by a divider shelf; and
wherein the divider shelf includes at least one aperture and at least one fan associated with the at least one aperture to move air from the lower section to the upper section of the cabinet.

22. The multi-level access enclosure system for an energy storage device of claim 16, further comprising a plurality of slotted shelves located in the lower potion of the cabinet.

23. The multi-level access enclosure system for an energy storage device of claim 22, further comprising a filter, wherein the filter is disposed in the lower section of the cabinet beneath the lowest slotted shelf.
